(19) United States
(12) Patent Application Publication
(10) Pub. No.: US 2013/0055354 A1
(43) Pub. Date: Feb. 28, 2013

(54) BUSINESS REVIEW RELEVANCE USING GEO-BASED HISTORY

(71) Applicants: Shira Weinberg, Tel Aviv (IL); Saar Yahalom, Tel Aviv (IL); Elad Gerson, Seattle, WA (US)

(72) Inventors: Shira Weinberg, Tel Aviv (IL); Saar Yahalom, Tel Aviv (IL); Elad Gerson, Seattle, WA (US)

(73) Assignee: Microsoft Corporation, Redmond, WA (US)

(21) Appl. No.: 13/216,234

(22) Filed: Aug. 23, 2011

(51) Int. Cl. H04L 9/32; G06N 5/04

(52) U.S. Cl. 726/4; 706/45

(57) ABSTRACT

Architecture that manages a location guestbook by enabling a user to add a review based on actually having visited the location. The location of the user can be validated as part of ensuring that the user visited the location. If a user did not actually visit the location the user is not allowed to add a review in the guestbook. The architecture can also identify that a user has left the location (checked out), and hence, suggest to the user to add a review for the location. If a user has visited the location multiple times, the user review is given a higher weighting, and hence, can be considered more reliable.

### BACKGROUND

Some platforms and websites offer online guestbook capabilities that enable users to review locations such as businesses. However, a problem with the review system is credibility where a user cannot determine who wrote the reviews, the honesty of the review, the position of the reviewer such as a visitor or a writer with vested interest. In many instances, the reviewers can be the restaurant owner, family, and friends. On the other hand the reviewer can be a competing restaurant owner who simply inputs a negative review of the competitor business without even visiting the place. Yet another issue is that a user tends to forget to add the review, because the momentum is lost (e.g., user wants to post a review, but when back home the user forgets to add the review).

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture manages a location guestbook by enabling a user to add a review only based on actually having visited the location. The location of the user can be validated as part of ensuring that the user visited the location. If a user did not actually visit the location the user is not allowed to add a review to the guestbook. The architecture can also identify that a user has left the location (checked out), and hence, suggest to the user to add a review for the location.

If a user has visited the location multiple times, the user review is given a higher weighting, and hence, can be considered more reliable. A permissions mechanism is provided that manages user review permissions based on location history.

It can also be inferred that the user has left a location followed by prompting the user to review the location after leaving, or when still at the location but preparing to leave the location. Additionally, the timing is managed such that the review cannot be input before the user experience of the location and not later than a predetermined time when the experience may be waning or has passed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that applies weighting to reviews.

FIG. 3 illustrates an alternative review management system for a business.

FIG. 4 illustrates a computer-implemented method in accordance with the disclosed architecture.

FIG. 5 illustrates further aspects of the method of FIG. 4.

FIG. 6 illustrates an alternative method in accordance with the disclosed architecture.

FIG. 7 illustrates further aspects of the method of FIG. 6.

FIG. 8 illustrates a method of adding a review on implicit check-out.

FIG. 9 illustrates a method of adding a review on implicit/explicit check-in.

FIG. 10 illustrates a method of adding a review based on past location history.

FIG. 11 illustrates a block diagram of a computing system that executes review processing in accordance with the disclosed architecture.

### DETAILED DESCRIPTION

The disclosed architecture manages web-based guestbooks associated with business and other sites, and enables users to add reviews based on actual visitation of the site. The user location (e.g., geolocation) can be employed to validate that the user was at a specified location. If the user did not physically visit the site, the user is not allowed to add a review to the guestbook about the site. If the user has visited the site multiple times, the user review can be given a higher weighting, and thus, considered to be a more reliable review.

The architecture identifies that the user has left a site (checked out) and prompts the user to add a review for the site. A permissions mechanism is employed that applies a permission based on location history of the user. If the past geolocation information of the user infers that the user has visited the site, the user can then post a review. It can also be inferred that a user has left the site (check-out). In this latter instance, the user can be prompted to review the site when leaving the site, and not before arriving at the site. Moreover, the user experience can become stale in that it is beneficial to also limit the time within which the user can create and post a review after the user has departed the site. For example, if the user has been away from the site for more than three days, the review may be too stale and hence, not as reliable as if the review was posted within a few hours of the visit.

The user location can be tracked using a mobile device, for example. The alternatives for the location input include, but are not limited to, obtainment by the device using GPS (global positioning system), cell towers, or WiFi. The user location information can be obtained from the mobile operator and/or acquired continuously (based on user consent) or by explicit user check-ins.

The architecture employs a location-based permissions model. The guestbook platform enables users to review a site only if the user physically visits the site. This model increases the credibility of the reviews by filtering “fake reviews” typically written by users that have a certain interest regarding the site, but did not physically visit the site.

A review can be increased in importance relative to other reviews such as weighting the review based on the number of visits the user had to the site. For example, a review from a returning customer will be given a higher weighting than a review from a one-time visitor in a restaurant.

As a means of facilitating the review process, a user can be prompted when or after leaving the site. Usually, a user does not review a business immediately after completing the visit (e.g. the user returns from a trip, signs in to a hotel guestbook, and leaves a review). In this scenario, it is desirable that the user be active after some time has passed from the visit to the site. This typically results in many users forgetting to review the site.

Other scenarios enable users to interact with the site such as when checking-in to the site (e.g., seated via a computer-based seating or reservation system) and/or checking out (e.g., paying the bill via a financial transaction). However, the users do not have the desired information in order to review the location (e.g., reviewing a restaurant when checking in, but before the food is served). Additionally, a user is allowed to add a “past review” according to a history of geolocation information. Each user can read the guestbook reviews posted by other users.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

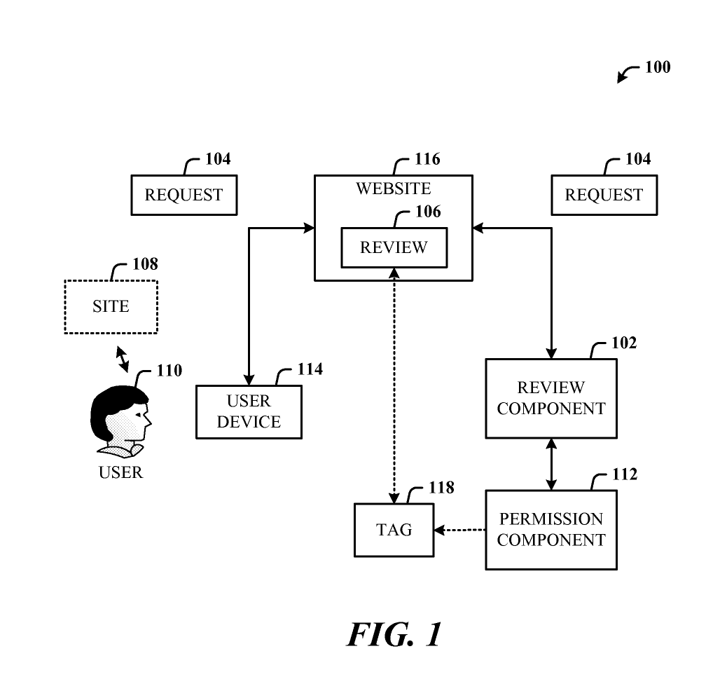

FIG. 1 illustrates a system 100 in accordance with the disclosed architecture. The system 100 includes a review component 102 that receives a request 104 to add a review 106 of a site 108 from a user 110, and a permission component 112 that manages the request 104 based on physical location of the user 110 relative to the site 108.

The physical location of the user 110 can be identified using a geolocation technology that operates with a mobile device (e.g., the user device 114) of the user 110. The request 104 is processed to allow the review 106 to be added (e.g., to a website 116) based on the physical location indicating visitation to the site 108 by the user 110. The review component 102 prompts the user 110 to add the review 106 relative to visitation of the site 108. The permission component 112 can infer at least one of arrival to, dwell (the time spent at the site 108), or departure from, the site 108.

The permission component 112 can apply a tag 118 (e.g., timestamp, and other metadata such as site name, location, etc.) to the review 106. The tag 118 maps the review 106 to a visit to the site 108 by the user 110.

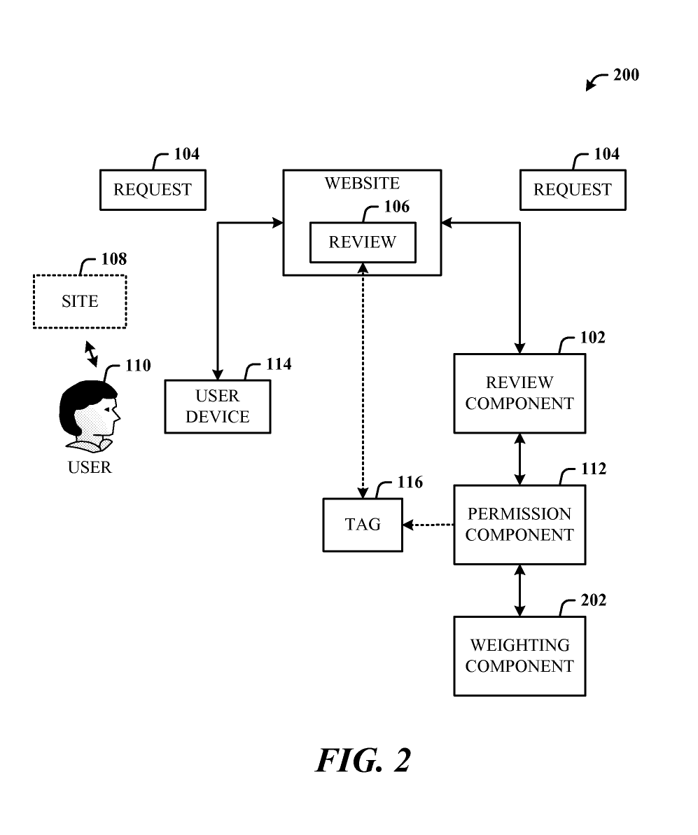

FIG. 2 illustrates an alternative system 200 that applies weighting to reviews. A weighting component 202 can weight the review 106 based on multiple visits by the user 110 to the site 108. A user who has visited the site 108 multiple times would know more about the site, and hence, the review is considered more credible than a user who has never visited the site 108. Alternatively, or in combination therewith, weighting can be applied based on the time of the review relative to departure from the site.

It is to be understood that where user information (e.g., identifying geolocation information) is performed, the user can be provided the option to opt-in or opt-out of allowing this information to be captured and utilized. Accordingly, a security component can be provided which enables the user to opt-in and opt-out of identifying geolocation information as well as personal information that may have been obtained and utilized thereafter.

The user can be provided with notice of the collection of information, for example, and the opportunity to provide or deny consent to do so. Consent can take several forms. Opt-in consent imposes on the user to take an affirmative action before the data is collected. Alternatively, opt-out consent imposes on the subscriber to take an affirmative action to prevent the collection of data before that data is collected. This is similar to implied consent in that by doing nothing, the user allows the data collection after having been adequately informed. The security component ensures the proper collection, storage, and access to the user information while allowing for the dynamic selection and presentation of the content, features, and/or services that assist the user to obtain the benefits of a richer user experience and to access to more relevant information.

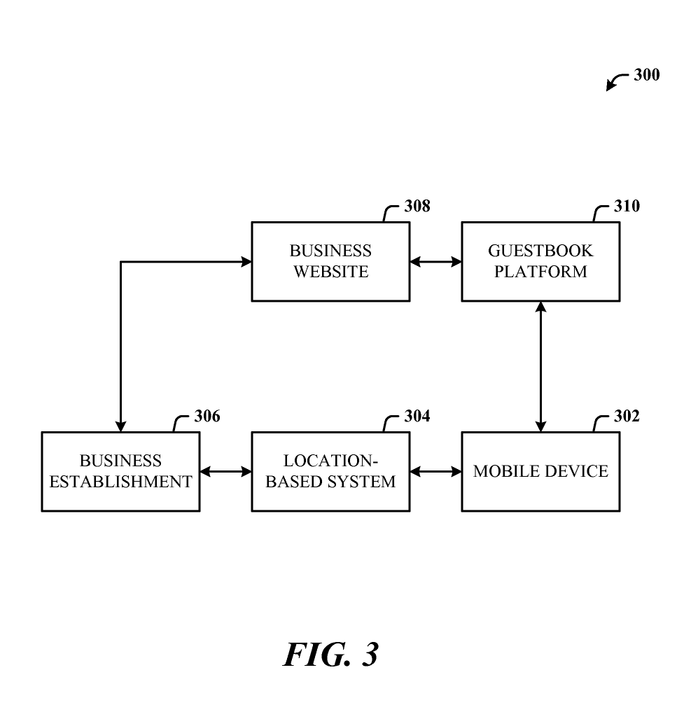

FIG. 3 illustrates an alternative review management system 300 for a business. The system 300 shows a mobile device 302 (e.g., user device 114 of FIG. 1) of a user that interfaces to a location-based system 304 to facilitate determining the geolocation information of the mobile device 302. The mobile device 302 is carried by the user to a business establishment 306. The business establishment 306 can have its own business website 308 and associated guestbook platform 310.

The guestbook platform 310 can comprise the review component 102, permission component 112, and optionally, the weighting component 202. The platform 310 then provides the capability to manage reviews and postings about the establishment 306 to the website 308.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

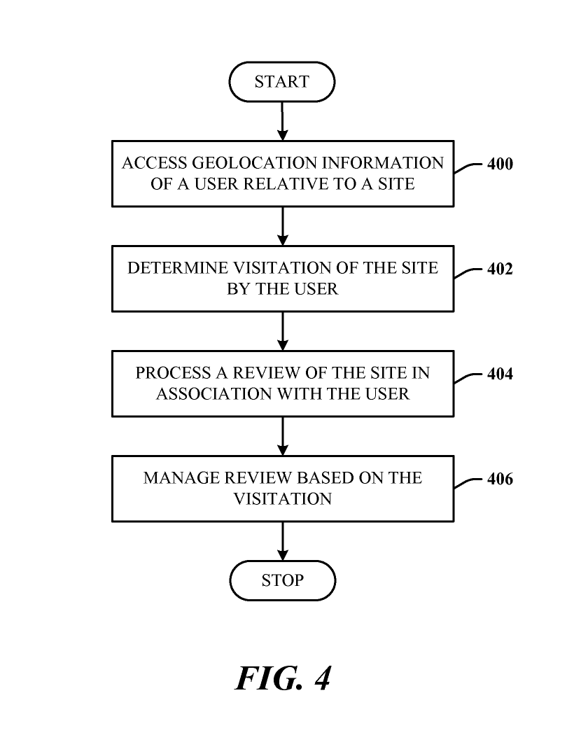

FIG. 4 illustrates a computer-implemented method in accordance with the disclosed architecture. At 400, geolocation information of a user relative to a site (e.g., geographic locations such as a business, scenic overlook, hiking trail, etc.) is accessed. At 402, visitation of the site by the user is determined. The visitation can be that the user is currently at the site. The visitation can be that the user has visited the site, and then departed the site. At 404, a review of the site is processed in association with the user. At 406, the review is managed based on the visitation. In other words, the review can be prevented from being created if it is determined that the user has not visited the site, and thus, the review has little credible value as to particular aspects about the site.

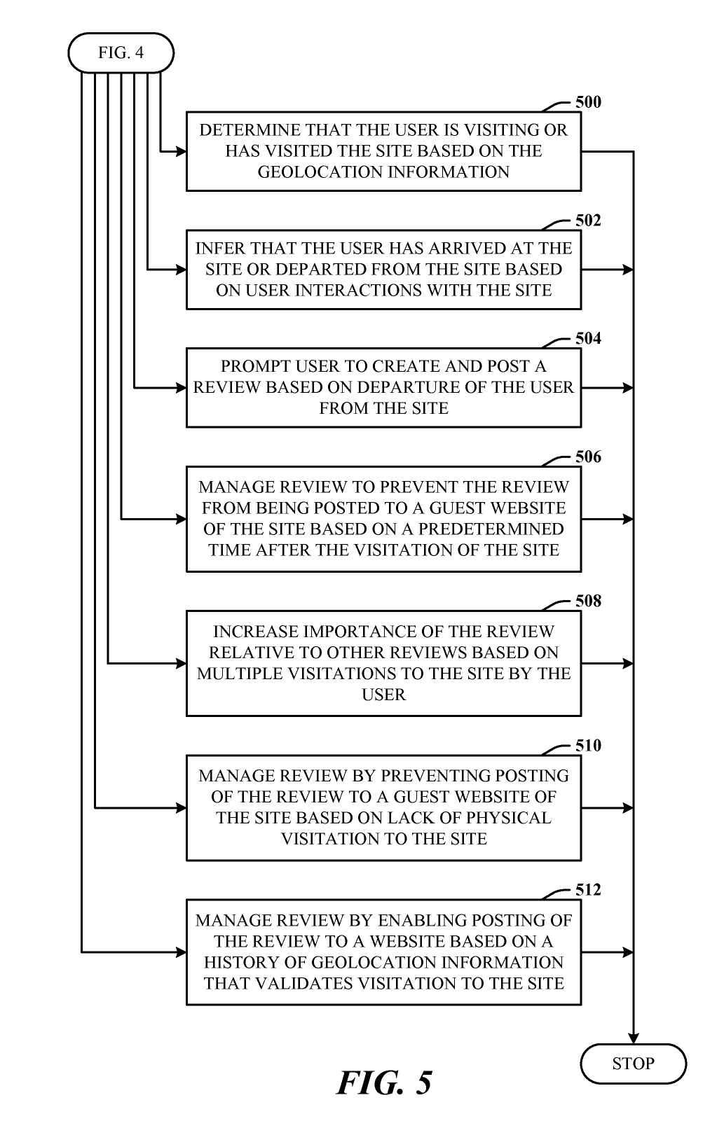

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, it is determined that the user is visiting or has visited the site based on the geolocation information. At 502, it is inferred that the user has arrived at the site or departed from the site based on user interactions with the site. At 504, the user is prompted to create and post a review based on departure of the user from the site.

At 506, the review is managed to prevent the review from being posted to a guest website of the site based on a predetermined time after the visitation of the site. At 508, importance of the review is increased relative to other reviews based on multiple visitations to the site by the user. At 510, the review is managed by preventing posting of the review to a guest website of the site based on lack of physical visitation to the site. At 512, the review is managed by enabling posting of the review to a website based on a history of geolocation information that validates visitation to the site.

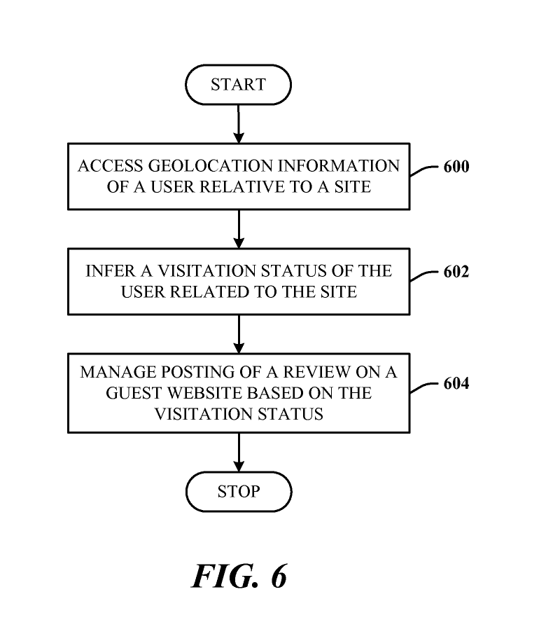

FIG. 6 illustrates an alternative method in accordance with the disclosed architecture. At 600, geolocation information (e.g., lat-long coordinates) of a user (and user device such as a mobile phone) relative to a site is accessed. The geolocation technology can be a geo-fence. At 602, a visitation status (e.g., at the site, having left the site) of the user related to the site is inferred. At 604, posting of a review on a guest website is managed based on the visitation status. In other words, the posting can be prevented or allowed.

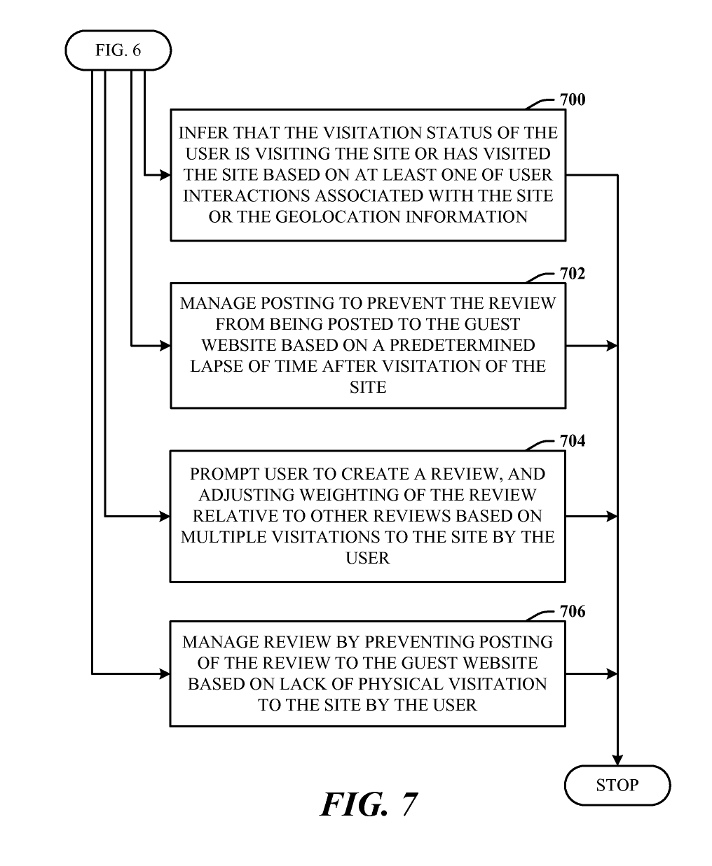

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, the visitation status of the user is inferred as visiting the site or has visited the site based on at least one of user interactions associated with the site or the geolocation information. At 702, the posting is managed to prevent the review from being posted to the guest website based on a predetermined lapse of time after visitation of the site. At 704, the user is prompted to create a review, and adjusting weighting of the review relative to other reviews based on multiple visitations to the site by the user. At 706, the review is managed by preventing posting of the review to the guest website based on lack of physical visitation to the site by the user.

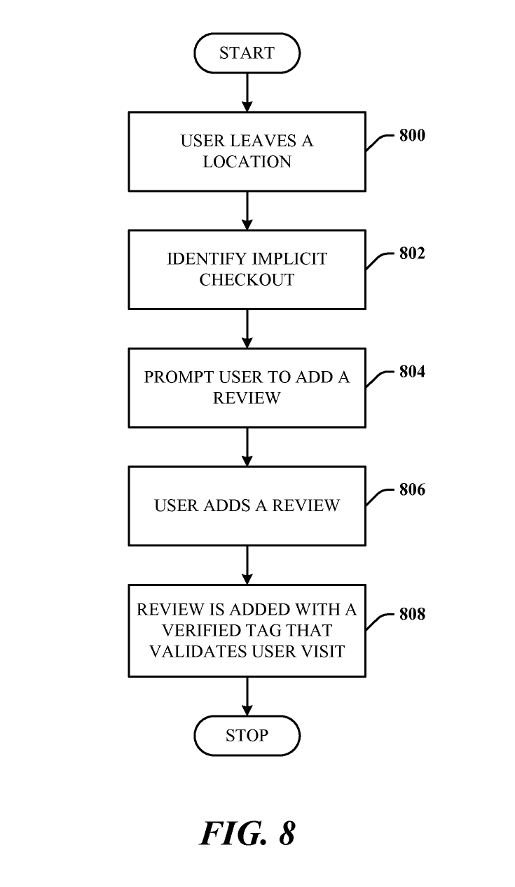

FIG. 8 illustrates a method of adding a review on implicit check-out. At 800, a user leaves a location. At 802, implicit checkout is identified (e.g., inferred). At 804, the user is prompted to add a review. At 806, the user adds the review. At 808, the review is added with a verified tag that validates the user visit.

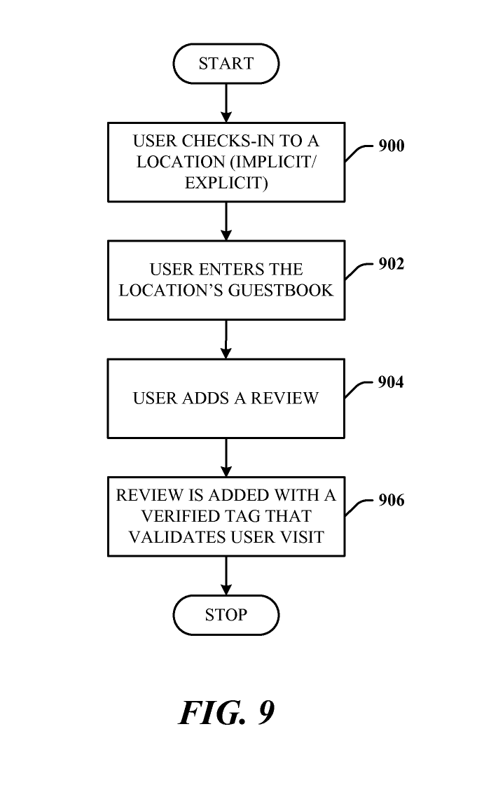

FIG. 9 illustrates a method of adding a review on implicit/explicit check-in. At 900, a user checks-in to a location. At 902, the user enters the location guestbook. At 904, the user adds a review. At 906, the review is added with a verified tag that validates the user visit.

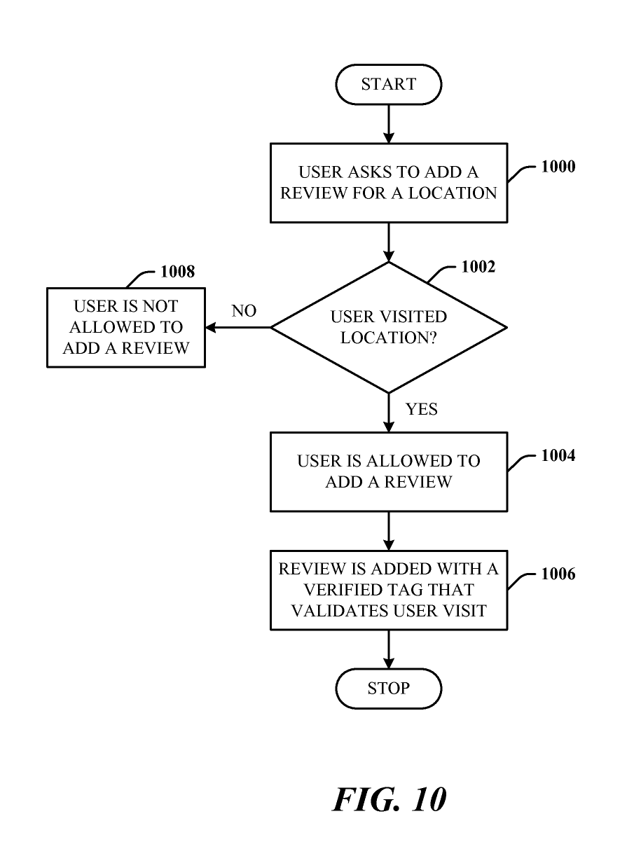

FIG. 10 illustrates a method of adding a review based on past location history. At 1000, a user requests to add a review for a location. At 1002, a check is made if the user actually visited the location. If yes, flow is to 1004, to allow the user to add the review. At 1006, the review is added with a verified tag that validates the user visit. However, if at 1002 it is determined has not visited the location, flow is to 1006 where the user is not allowed to add the review.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

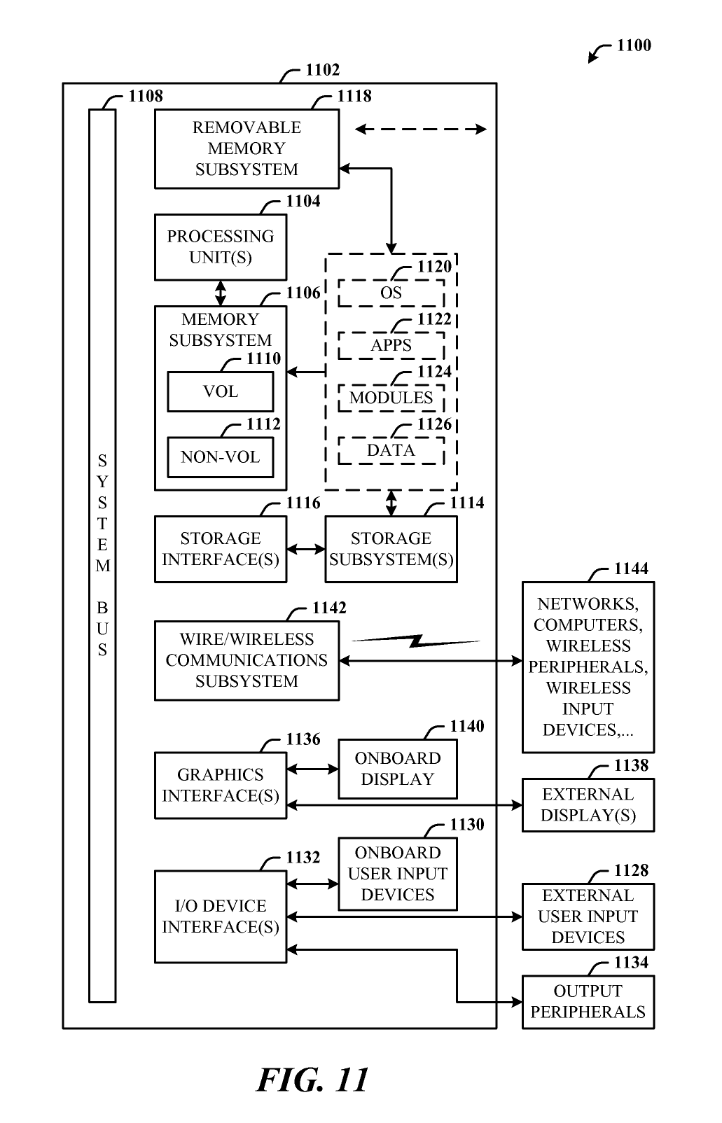

Referring now to FIG. 11, there is illustrated a block diagram of a computing system 1100 that executes review processing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and components of the system 200 of FIG. 2, entities and components of the system 300 of FIG. 3, and methods represented by the flowcharts of FIGS. 4-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1102 and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
a review component that receives a request to add a review of a site from a user;
a permission component that manages the request based on physical location of the user relative to the site; and
a processor that executes computer-executable instructions associated with at least one of the review component or the permission component.

2. The system of claim 1, wherein the physical location of the user is identified using a geolocation technology that operates with a mobile device of the user.

3. The system of claim 1, wherein the request is processed to allow the review to be added based on the physical location indicating visitation to the site by the user.

4. The system of claim 1, wherein the review component prompts the user to add the review relative to visitation of the site.

5. The system of claim 1, wherein the permission component infers at least one of arrival to, dwell at, or departure from, the site.

6. The system of claim 1, wherein the permission component applies a tag to the review, the tag maps the review to a visit to the site by the user.

7. The system of claim 1, further comprising a weighting component that weights the review based on multiple visits to the site.

8. A computer-implemented method, comprising acts of:
accessing geolocation information of a user relative to a site;
determining visitation of the site by the user;
processing a review of the site in association with the user;
managing the review based on the visitation; and
utilizing a processor that executes instructions stored in memory to perform at least one of the acts of receiving, accessing, determining, or managing.

9. The method of claim 8, further comprising determining that the user is visiting or has visited the site based on the geolocation information.

10. The method of claim 8, further comprising inferring that the user has arrived at the site or departed from the site based on user interactions with the site.

11. The method of claim 8, further comprising prompting the user to create and post a review based on departure of the user from the site.

12. The method of claim 8, further comprising managing the review to prevent the review from being posted to a guest website of the site based on a predetermined time after the visitation of the site.

13. The method of claim 8, further comprising increasing importance of the review relative to other reviews based on multiple visitations to the site by the user.

14. The method of claim 8, further comprising managing the review by preventing posting of the review to a guest website of the site based on lack of physical visitation to the site.

15. The method of claim 8, further comprising managing the review by enabling posting of the review to a website based on a history of geolocation information that validates visitation to the site.

16. A computer-implemented method, comprising acts of:
accessing geolocation information of a user relative to a site;
inferring a visitation status of the user related to the site;
managing posting of a review on a guest website based on the visitation status; and
utilizing a processor that executes instructions stored in memory to perform at least one of the acts of receiving, accessing, determining, or managing.

17. The method of claim 16, further comprising inferring that the visitation status of the user is visiting the site or has visited the site based on at least one of user interactions associated with the site or the geolocation information.

18. The method of claim 16, further comprising managing the posting to prevent the review from being posted to the guest website based on a predetermined lapse of time after visitation of the site.

19. The method of claim 16, further comprising prompting the user to create a review, and adjusting weighting of the review relative to other reviews based on multiple visitations to the site by the user.

20. The method of claim 16, further comprising managing the review by preventing posting of the review to the guest website based on lack of physical visitation to the site by the user.
